(19) United States
(12) Patent Application Publication
(10) Pub. No.: US 2024/0361347 A1
(43) Pub. Date: Oct. 31, 2024

(54) SAMPLE PREPARATION CARTRIDGE AND AUTOMATIC ANALYZER

(71) Applicant: Canon Medical Systems Corporation, Otawara-shi (JP)

(72) Inventor: Shozo HASHIMOTO, Nasushiobara (JP)

(73) Assignee: Canon Medical Systems Corporation, Otawara-shi (JP)

(21) Appl. No.: 18/638,781

(22) Filed: Apr. 18, 2024

(30) Foreign Application Priority Data
Apr. 28, 2023 (JP) 2023-074514

(51) Int. Cl. G01N 35/04; G01N 35/02; G01N 35/10

(52) U.S. Cl. CPC G01N 35/04; G01N 35/025; G01N 35/1002

(57) ABSTRACT

According to one embodiment, a sample preparation cartridge includes, in a container, a first capture unit which captures an inclusion, a second capture unit provided spaced apart from the first capture unit, which captures a contaminant, a first space provided on one surface side of the first capture unit, a second space provided on one surface side of the second capture unit, and an inflow channel on the other surface side of the second capture unit, the second space is provided in parallel with the first space, and the first space and the second space are communicated to a third space between the first capture unit and the second capture unit.

### CROSS-REFERENCE TO RELATED APPLICATIONS

This application is based upon and claims the benefit of priority from Japanese Patent Application No. 2023-074514, filed Apr. 28, 2023, the entire contents of which are incorporated herein by reference.

### FIELD

Embodiments described herein relate generally to a sample preparation cartridge for mass spectrometry, particularly for the preparation of samples containing mineral and protein components and blood samples.

### BACKGROUND

Conventional mass spectrometers are configured to store samples prepared for analysis in a sample storage area that is provided separate from the sample preparation area. Such devices require a washing mechanism for the container in which the prepared sample is stored, or in the case of a disposable container, a provision of the container and a liquid waste discarding function, thereby making it difficult to miniaturize the device.

Further, when there are two or more capture units that capture a given substance such as a contaminant, the conventional device has a configuration in which each capture unit is arranged on a single flow path. Here, since the captures are disposed on one flow path, if a contaminant captured by the first capture unit passes therethrough, the contaminant having passed the first capture unit may be send to the second capture unit undesirably. Further, if the first capture unit is clogged, the second capture unit may not function sufficiently because the liquid cannot be supplied sufficiently to the second capture unit which follows.

### BRIEF DESCRIPTION OF THE DRAWINGS

FIG. 1 is a cross-sectional view showing a sample preparation cartridge of a sample suction type.

FIG. 2 is a scheme diagram illustrating the method for using the sample preparation cartridge in the first embodiment, including parts (a) to (d) each being a cross-sectional view of the sample preparation cartridge.

FIG. 3 is a flowchart of a method for using the sample preparation cartridge in the first embodiment.

FIG. 4 is a scheme diagram illustrating a method for using a sample preparation cartridge in the second embodiment, including parts (a) to (g) each being a cross-sectional view of the sample preparation cartridge.

FIG. 5 is a flowchart of a method for using the sample preparation cartridge in the second embodiment.

FIG. 6 is a cross-sectional view of the sample preparation cartridge of a sample supply type according to the third embodiment.

FIG. 7 is a scheme diagram illustrating a method for using the sample preparation cartridge in the third embodiment, including parts (a) to (e) each being a cross-sectional view of the sample preparation cartridge.

FIG. 8 is a flowchart of a method of using the sample preparation cartridge in the third embodiment.

FIG. 9 is a scheme diagram illustrating a method for using the sample preparation cartridge in the fourth embodiment, including parts (a) to (g) each being a cross-sectional view of the sample preparation cartridge.

FIG. 10 is a flowchart of a method for using the sample preparation cartridge in the fourth embodiment.

FIG. 11 is a block diagram of an automatic analyzer using a sample preparation cartridge.

FIG. 12 is a perspective view showing a structure of an analysis unit of the automatic analyzer.

FIG. 13 is a block diagram of an automatic analyzer using a sample preparation cartridge of a sample suction type.

FIG. 14 is a flowchart of an analysis procedure of the automatic analyzer using a sample preparation cartridge of a sample suction type.

### DETAILED DESCRIPTION

In general, according to one embodiment, a sample preparation cartridge comprises, in a container, a first capture unit which captures an inclusion, a second capture unit provided spaced apart from the first capture unit, which captures a contaminant, a first space provided on one surface side of the first capture unit, a second space provided on one surface side of the second capture unit, and an inflow channel on the other surface side of the second capture unit, the second space is provided in parallel with the first space, and the first space and the second space are communicated to a third space between the first capture unit and the second capture unit.

According to the sample preparation cartridge of an embodiment, the cartridge container can include a sample preparation area in which samples are prepared and a sample retaining area which retains prepared samples, and with this structure, prepared samples can be dispensed directly from the sample preparation cartridge to the analysis unit.

Further, since the capture units are arranged on separate flow paths, respectively, the possibility of a given substance, such as a contaminant, reaching the following capture unit can be reduced. Furthermore, it is possible to dispense a sample and supply an equilibrating liquid of a solid-phase extractant at the same time, and therefore the turn around time (TAT) can be shortened.

In addition, according to an automatic analyzer using the sample preparation cartridge of the embodiment, the prepared sample retained in the sample preparation cartridge can be directly dispensed to the analysis unit, and therefore it is not necessary to provide a separate preparation sample storage area or a preparation sample storage container in the device, thereby making the analyzer more compact. Further, since the prepared sample storage area is no longer necessary, the cost of measurement can be reduced. Moreover, since the prepared sample storage container is no longer necessary, the process of cleaning the container or the supply and disposal mechanism of the storage container are no longer required, thus reducing the measurement cost.

Embodiments will be described hereinafter with reference to the accompanying drawings. Throughout the embodiments, common elements are denoted by like reference numerals, and a detailed description thereof may be omitted unless otherwise necessary. Further, in order to make the description clearer, the widths, thicknesses, shapes, ratio, etc., of the respective parts are schematically illustrated in the drawings, compared to the actual modes. These parts can be redesigned or remodeled as needed with reference to each drawing, the following descriptions and the conventional techniques.

### First Embodiment

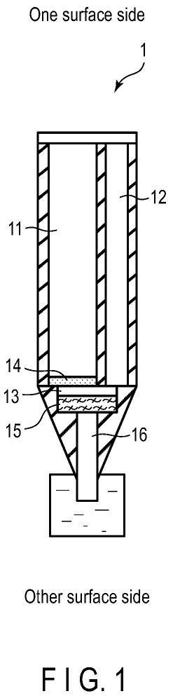

An example of a sample preparation cartridge used in the first embodiment will now be described with reference to FIG. 1. FIG. 1 is a cross-sectional view of a sample preparation cartridge 1 of a sample suction type. The suction type sample preparation cartridge 1 comprises a first space 11, a second space 12, a third space 13, a first capture unit 14, a second capture unit 15 and an inflow channel 16 in the cartridge container. The first space 11 is provided on one surface side of the first capture unit 14 and the second space 12 is on one surface side of the second capture unit 15. The inflow channel 16 is provided on the other side of the second capture unit 15. The second space 12 is provided in parallel with the first space 11, and the first space 11 and the second space 12 are communicated to the third space 13 between the first capture unit 14 and the second capture unit 15.

The first capture unit 14 and the second capture unit 15 may as well be filters to remove foreign substances and the like, or solid-phase extractant which can specifically capture particular components.

The suction type sample preparation cartridge 1 may as well be provided with, for example, a check valve in the inflow channel 16 so as to prevent suctioned samples from flowing out. For the prevention of outflow, a means which can block a sample suction unit in the inflow channel 16 may as well be used.

The material of the container used for the cartridge part in the sample preparation cartridge is, for example, polystyrene, which is chemically stable, or the like.

The material of the filters used for the capture units is, for example, glass fiber, polyurethane, polyester or the like. The pore size of the mesh of such filters is about 0.5 to 2.0 μm.

The solid-phase extractant used for the capture units is, for example, zirconia-silica gel, synthetic polymers such as polystyrene divinylbenzene or the like.

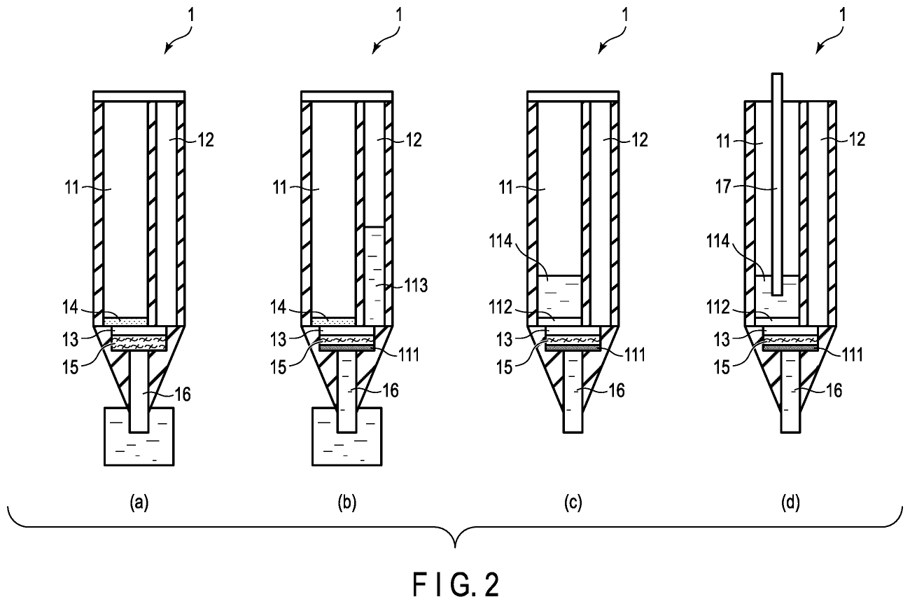

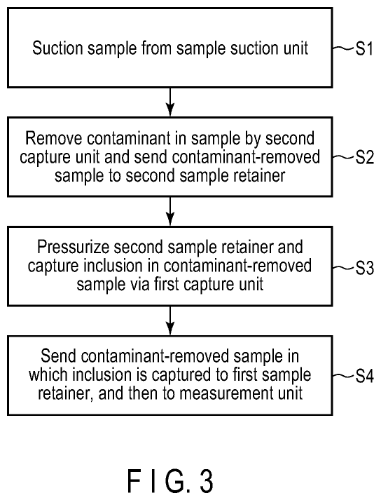

Next, an example of a method for using the suction type sample preparation cartridge in the first embodiment will be described with reference to FIGS. 2 and 3. FIG. 2 is a scheme diagram showing an example of the procedure for using the suction type sample preparation cartridge 1 in the first embodiment, and parts (a) to (d) are each a cross-sectional view of the sample preparation cartridge. FIG. 3 is a flowchart illustrating an example of the procedure for using the suction type sample preparation cartridge in the first embodiment.

The first space 11 (a first sample retainer) is closed and the second space 12 (a second sample retainer) is depressurized (FIG. 2, part (b) and FIG. 3, (S1)) to suction the sample and send it through the inflow channel 16 to the second capture unit 15. A contaminant 111 in the sample is captured in the second capture unit 15 and removed from the sample (FIG. 2, part (b) and FIG. 3, (S2)). A filter or a solid-phase extractant which can specifically bind to a particular component is used for the second capture unit 15. Here, undesired inclusions are captured by the solid-phase extractant for the removal by adsorption, and the solution that has passed through the solid-phase extraction cartridge is used as a sample solution for measurement. Although will be described in detail later, a reagent is added to the sample in advance before the cartridge suctions the sample. The reagent contains a component that specifically binds to the contaminant 111 in the sample.

When the reagent is added to the sample, the component in the reagent reacts with the contaminant 111 in the sample and specifically binds thereto. The contaminant 111 bound to the component in the reagent enlarges in volume, greater than that of the contaminant 111 alone. Because of the greater volume, the contaminant 111 bound to the component of the reagent can be easily captured by the filter to be removed from the sample. Note that the contaminant 111 in the sample is a phospholipid, a high molecular weight protein or the like.

For example, in the case where the contaminant 111 in the sample is a phospholipid, titania or zirconia particles, for example, can be used as the reagent. A phospholipid bound to titania or zirconia particles have a larger volume as compared to the phospholipid by itself and is easily captured by the filter, thus enabling removal of the contaminant 111, a phospholipid, from the sample.

For example, in the case where the contaminant 111 in the sample is a high molecular weight protein, methanol, for example, can be used as the reagent. When methanol reacts with the high molecular weight protein, the protein precipitation occurs. The protein precipitates thus generated are greater in volume as compared to that of the high molecular weight protein, and are easily captured by the filter, thus making it easy to remove, from the sample, the high molecular weight protein, which is the contaminant 111.

After the contaminant 111 is removed in the second capture unit 15, a sample 113, from which the contaminant has been removed, is sent through the third space 13 (a third sample retainer) to the second space 12 and thus the contaminant-removed sample 113 is held in the second space 12 (FIG. 2, part (b)). Next, the upper surface of the sample preparation cartridge 1 of the sample suction type is closed, the second space 12 is pressurized and the first space 11 is depressurized. Thus, the contaminant-removed sample 113 in the second space 12 is sent into the first space 11 via the first capture unit 14. In the first capture unit 14, an inclusion 112 in the contaminant-removed sample 113 is captured (FIG. 2, parts (b) and (c) and FIG. 3, (S3)). If the sample in the second space 12 can be sent to the first space 11 only by pressurization, it may suffice if the pressure of the second space 12 is increased. Then, a remainder 114 of the sample, which is held in the first space 11 is suctioned by a suction tube 17, and the remainder 114 is dispensed to an analysis unit 80 of the automatic analyzer (FIG. 2, part (d) and FIG. 3, (S4)).

According to the first embodiment, the prepared sample that has been prepared by passing it through the first capture units 14 and the second capture unit 15 can be held in the sample preparation cartridge 1, and therefore the prepared sample can be dispensed directly from the sample preparation cartridge 1 to the analysis unit 80. Further, even if the second capture unit 15 is clogged with the contaminant 111 or the like, the sending of liquid in the first capture unit 14 will not be affected.

### Second Embodiment

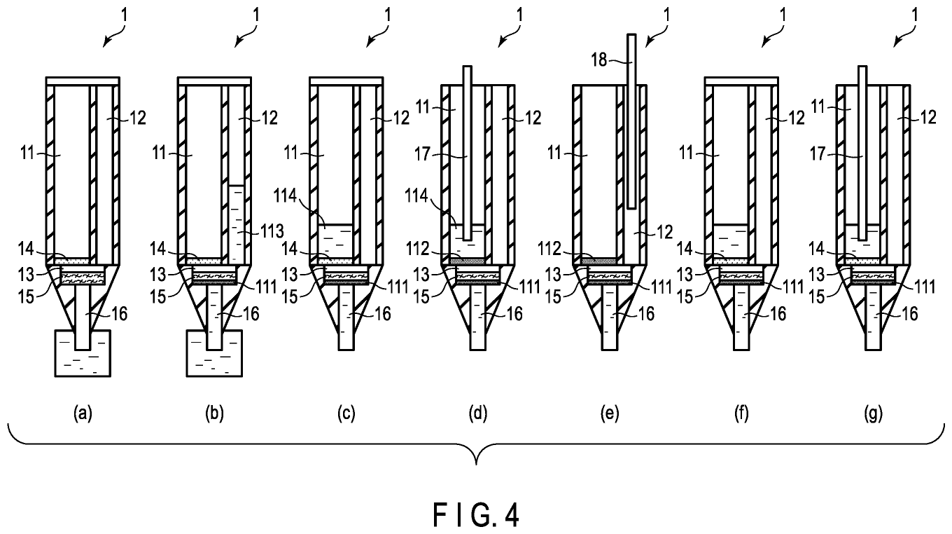

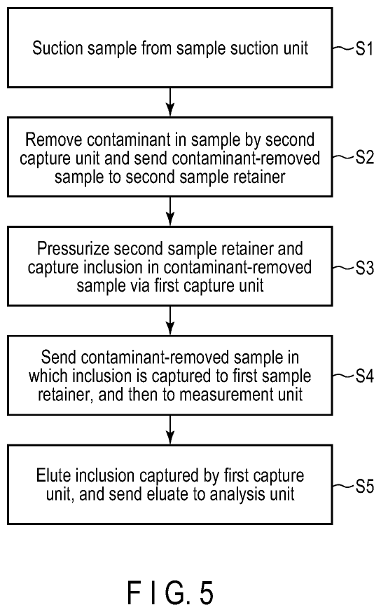

An example of a method for using a sample preparation cartridge of a suction type in the second embodiment will now be described with reference to FIGS. 4 and 5. FIG. 4 is a scheme diagram showing an example of the procedure for using a sample preparation cartridge 1 of the suction type in the second embodiment, including parts (a) to (g) each illustrating a cross-sectional view of the sample preparation cartridge. FIG. 5 is a flowchart illustrating an example of the procedure for using the sample preparation cartridge of the suction type in the second embodiment. The sample preparation cartridge used in the second embodiment is the same as the suction type sample preparation cartridge 1 shown in FIG. 1, in which, furthermore, a solid-phase extractant is used for the first capture unit 14.

After dispensing the remainder 114 of the sample to the analysis unit of the automatic analyzer in the first embodiment, a liquid which can elute the inclusion 112 captured in the first capture unit 14 is sent from the upper surface of the second space 12 by the feed tube 18 (FIG. 4, part (e)). Then, the liquid in the second space 12 is sent to the first capture unit 14 by a method based on pressure change, similar to that described above, and the inclusion 112 captured by the first capture unit 14 is eluted. Further, the second space 12 is pressurized and the first space 11 is depressurized, and thus, an eluate in which the inclusion 112 is eluted is sent to the first space 11 and the eluate is retained in the first space 11 (FIG. 4, part (f)). Note that if the sample in the second space 12 can be sent to the first space 11 only by pressurization, then it suffices just if the pressure of the second space 12 is increased. The eluate held in the first space 11 is suctioned and dispensed into the analysis unit 80 of the automatic analyzer (FIG. 4, part (g) and FIG. 5, (S5)).

According to the second embodiment, advantageous effects similar to those of the first embodiment can be achieved, and further two types of substances to be analyzed can be obtained from one sample and dispensed into the analysis unit of the automatic analyzer.

### Third Embodiment

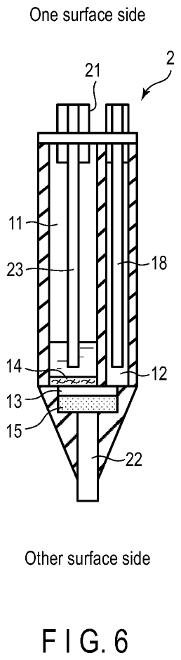

An example of a sample preparation cartridge used in the third embodiment will be described with reference to FIG. 6. FIG. 6 is a cross-sectional view showing a sample preparation cartridge 2 of a sample supply type. The supply type sample preparation cartridge 2 comprises a first space 11, a second space 12, a third space 13, a first capture unit 14, a second capture unit 15, a sample supply unit 21 and an outflow channel 22 in the cartridge container. The first space 11 is provided on one surface side of the first capture unit 14, the second space 12 is on one surface side of the second capture unit 15, and the outflow channel 22 is on the other surface side of the second capture unit 15. The third space 13 is provided between the first capture unit 14 and the second capture unit 15. The second space 12 is provided in parallel with the first space 11, and the first space 11 and the second space 12 are communicated to the third space 13.

The first capture unit 14 and the second capture unit 15 may be filters to remove a contaminant 111 or solid phase extractants that can specifically capture inclusion.

A check valve may be provided at a lower part of the first capture unit 14 to prevent the sample that reaches the second capture unit 15 from flowing back into the first capture unit 14. By using such a check valve, it is possible to omit the means for closing the opening of the first capture unit 14.

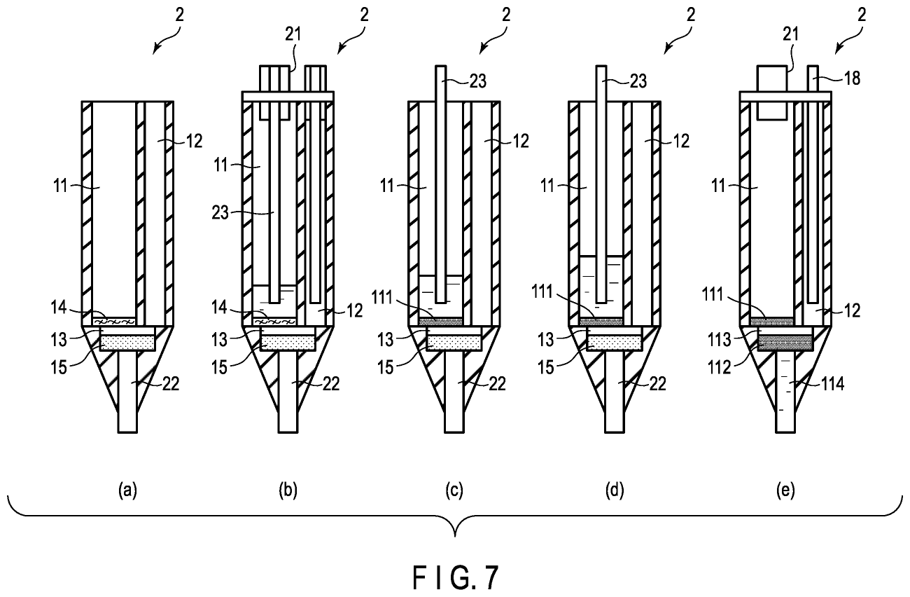

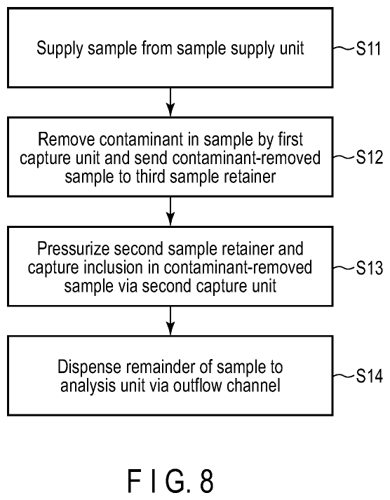

Next, an example of a method for using the supply type sample preparation cartridge in the third embodiment will be described with reference to FIGS. 7 and 8. FIG. 7 is a scheme diagram showing an example of the procedure of using the supply type sample preparation cartridge 2 in the third embodiment, including parts (a) to (e) each illustrating a cross-sectional view of the sample preparation cartridge. Further, FIG. 8 is a flowchart illustrating an example of the procedure of using the supply type sample preparation cartridge 2 in the third embodiment.

First, a sample is supplied from a sample supply unit 21 via a supply tube 23, sent into the first space 11, and retained there (FIG. 7, part (b) and FIG. 8, (S11)). Next, a reagent that binds to the contaminant 111 is dispensed into the first space 11 via the supply tube 23 (FIG. 7, part (c) and part (d)). If there are two or more reagents to be dispensed, the reagents may be dispensed at the same time or each may be dispensed separately.

Next, the opening of the outflow channel 22 communicated to the second capture unit 15 is closed and the first space 11 is pressurized, and thus the sample held in the first space 11 is sent via the first capture unit 14 to the third space 13, where the sample is retained (FIG. 7, part (e) and FIG. 8, (S12)). The contaminant 111 in the sample is captured and removed from the sample by the first capture unit 14 when it is passed through the first capture unit 14. Further, with the first space 11 and the second space 12 closed, the second space 12 is pressurized, and a sample 113 in the third space 13, from which the contaminant has been removed is sent to the second capture unit 15. In the second capture unit 15, an inclusion 112 in the contaminant-removed sample 113 is captured (FIG. 7, part (e) and FIG. 8, (S13)). A remainder of the sample 114 passes through the outflow channel 22 and is dispensed to the analysis unit 80 of the automatic analyzer (FIG. 7, part (e) and FIG. 8, (S14)).

According to this third embodiment, as in the case of the first embodiment, a prepared sample can be dispensed directly from the sample preparation cartridge to the analysis unit 80 of the automatic analyzer. Further, even if clogging occurs in the first capture unit 14, the feeding of the fluid in the second capture unit 15 will not be affected, which is an additional advantageous effect.

### Fourth Embodiment

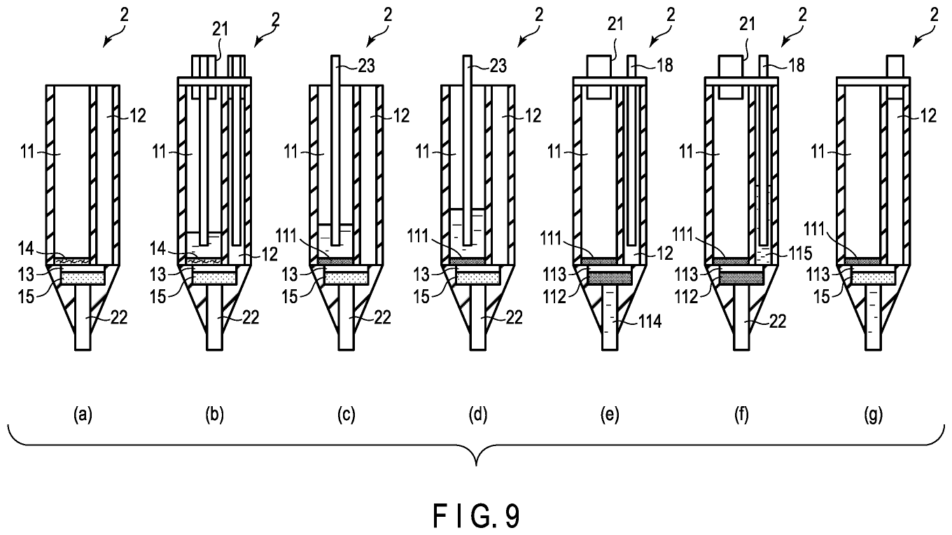

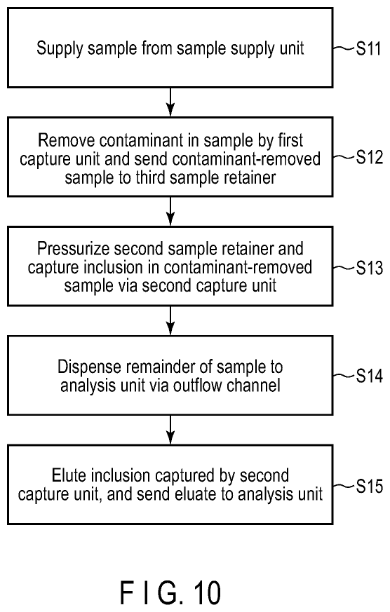

An example of a method of using of a sample preparation cartridge of a supply type in the fourth embodiment will be described with reference to FIGS. 9 and 10. FIG. 9 is a scheme diagram showing an example of the procedure of using the supply type sample preparation cartridge 2 in the fourth embodiment, including part (a) to (g) each illustrating a cross-sectional view of the sample preparation cartridge. FIG. 10 is a flowchart illustrating an example of the procedure for using the supply type sample preparation cartridge 2 in the fourth embodiment. The sample preparation cartridge used in the fourth embodiment is the same as that supply type sample preparation cartridge 2 shown in FIG. 6, and furthermore, a solid-phase extractant is used for the second capture unit 15.

After dispensing the remainder 114 of the sample to the analysis unit 80 of the automatic analyzer in the third embodiment, a liquid 115 which can elute an inclusion 112, captured in the second capture unit 15, is sent from the upper surface of the second space 12 via the supply tube 18 to the second space 12, where the liquid is retained (FIG. 9, part (f) and FIG. 10, (S15)). After that, the second space is pressurized while the first space is closed, and the liquid 115 in the second space 12 is sent to the second capture unit 15 to elute the inclusion 112 captured in the second capture unit 15 therein, thus obtaining an eluate. Further, the second space 12 is pressurized, and thus the eluate is dispensed through the outflow channel 22 to the analysis unit 80 of the automatic analyzer (FIG. 9, part (g) and FIG. 10, (S15)).

According to the fourth embodiment, advantageous effects similar to those of the third embodiment can be achieved, and further, two types of substances to be analyzed can be obtained from one sample and dispensed into the analysis unit of the automatic analyzer.

### Fifth Embodiment

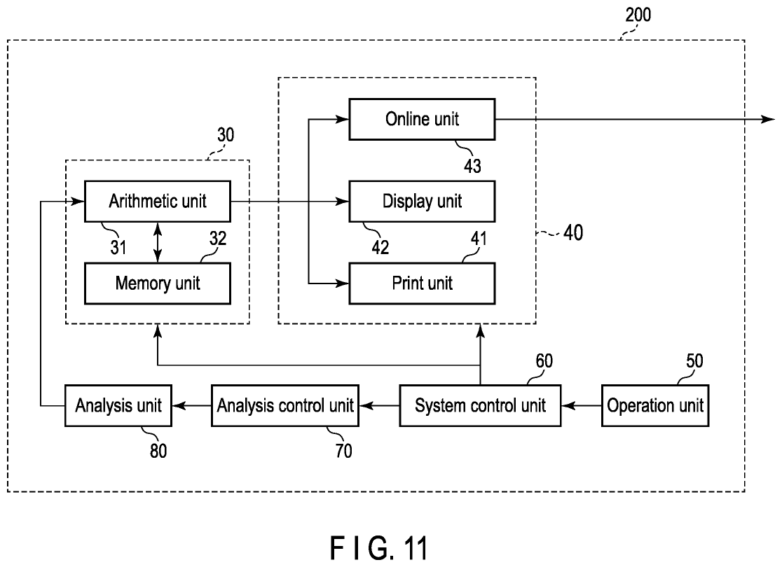

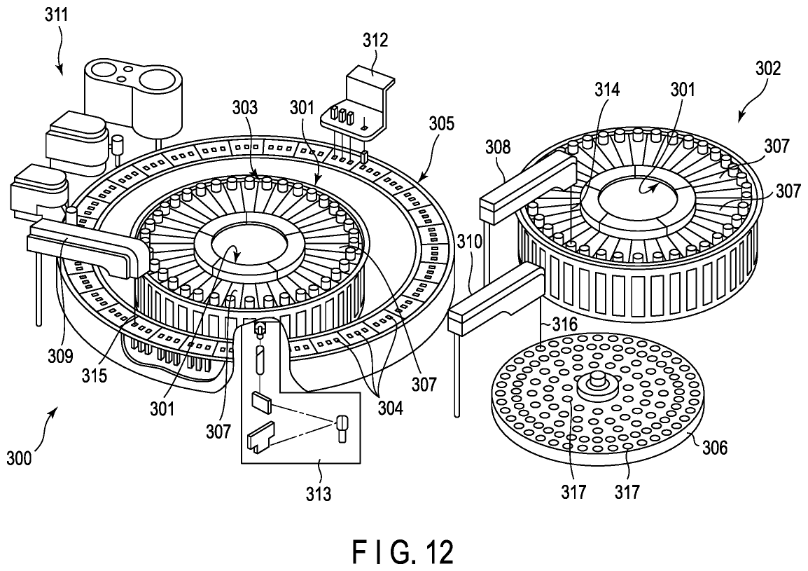

As the fifth embodiment, an example of an automatic analyzer which uses a sample preparation cartridge will be described with reference to FIGS. 11 and 12.

FIG. 11 is a block diagram showing a system of an automatic analyzer 200 which uses a sample preparation cartridge. The automatic analyzer 200 comprises an analysis unit 80 which measures a test sample and a calibrator, an analysis control unit 70 that controls the analysis unit 80, an analysis data processing unit 30 that processes an analysis signal output from the analysis unit 80 to calculate out analysis data, an output unit 40 that outputs analysis data from the analysis data processing unit 30, an operation unit 50 which inputs analysis conditions and various types of command signals and a system control unit 60 which controls these units described above collectively. The analysis data processing unit 30 comprises an arithmetic unit 31 and a memory unit 32. The output unit 40 comprises a print unit 41, a display unit 42 and an online unit 43.

The analysis control unit 70 comprises mechanisms and a control unit for each of the mechanisms which perform the pivot of each of reagent storage units 302 and 303 and a disk sampler 306, the rotation of a reaction disk 305, the pivot and vertical movement of each of a dispensing arm 310, a first reagent dispensing arm 308, a second reagent dispensing arm 309 and a stirring unit 311 and the vertical movement of the washing unit 312 and the like, all of which are provided in the analysis unit 80, as will be described later in detail. Further, the analysis control unit 70 comprises various types of pumps and control units for these pumps, the pumps including a dispensing pump which suctions and discharges the test sample and the calibrator via the dispensing probe 316, a first reagent pump which suctions and discharges a first reagent via a first reagent dispensing probe 314, a second reagent pump which suctions and discharges a second reagent via a second reagent dispensing probe 315, a washing pump which supplies and suctions a washing liquid for washing the inside of the reaction tube 304 via a washing unit 312, and a drying pump which dries the inside of the reaction tube 304. Furthermore, the analysis control unit 70 comprises a mechanism which drives the stirring unit 311 to stir and control unit.

FIG. 12 is a perspective view showing a structure of the analysis unit 80 of the automatic analyzer 200.

The analysis unit 80 comprises a reagent storage unit 302, a reagent storage unit 303, a reaction disk 305 in which reaction tubes 304 are disposed and a disk sampler 306 in which test sample containers 317 each to accommodate a test sample or a calibrator are set. Further, in the reagent storage unit 302 and the reagent storage unit 303, a reagent rack 301 accommodating reagent bottles 307 is placed. The reagent bottles 307 store reagents such as a first reagent that reacts selectively to the sample to be tested and the calibrator for the sample and a second reagent paired with the first reagent. The reaction tubes 304 are arranged on the reaction disk 305 in circumferential positions.

Further, the analysis unit 80 comprises a dispensing probe 316 that dispenses a sample into a reaction tube 304 which is stopped at a test sample dispensing position, a first regent dispensing probe 314, a second reagent dispensing probe 315, a dispensing arm 310, a first dispensing arm 308 and a second dispensing arm 309. The dispensing arms 310, 308 and 309 pivotably and vertically movably hold the dispensing probes 316, 314 and 315, respectively. The analysis unit 80 comprises a washing unit 312 which washes and dries the inside of the reaction tubes 304. Moreover, the analysis unit 80 comprises a photometric unit 313.

The reagent storage unit 302, the reagent storage unit 303 and the disk sampler 306 are each pivoted for each one cycle, and the reaction disk 305 is rotated and stopped at a position controlled by the analysis control unit 70. In the analysis unit 80, for each one cycle, the first reagent dispensing probe 314 and the second reagent dispensing probe 315 suction the first reagent and the second reagent from the reagent bottles 307 set at the first reagent suctioning position and the second reagent suctioning position of the reagent storage unit 302 and the reagent storage unit 303, respectively. After suctioning each reagent, the first reagent dispensing probe 314 and the second reagent dispensing probe 315 dispense the reagents into the reaction tubes 304 stopped at the first reagent dispensing position and the second reagent dispensing position, respectively. The dispensing probe 316 suctions the test sample or the calibrator in the test sample container 317 set at the position controlled by the analysis control unit 70 of the disk sampler 306, and dispenses it into the respective reaction tube 304. Further, the analysis unit 80 comprises a stirring unit 311 which stirs the mixed solution in the reaction tube 304 stopped at a stirring position, a photometric unit 313 that measures the reaction tube 304 containing the mixed solution from a photometric position and a washing unit 312 that suctions the mixed solution that has been measured in the reaction tube 304 stopped in a washing and drying position, and further washes and dries the inside thereof, for each one cycle. The mixed solution in the reaction tube 304 stopped at the stirring position is a mixture of a test sample and the first reagent, a mixture of a calibrator and the first reagent, a mixture of a test sample, the first reagent and the second reagent, or a mixture of a calibrator, the first reagent and the second reagent. The photometric unit 313 irradiates light from the photometric position to the reaction tube 304 while rotating to measure the change in absorbance of the mixed solution, and outputs an analysis signal of the test sample obtained from the measurement or calibration signal of calibrator to an analysis data processing unit 30. The reaction tube 304, which has been washed and dried after the measurement of the mixture, is used again for other measurements.

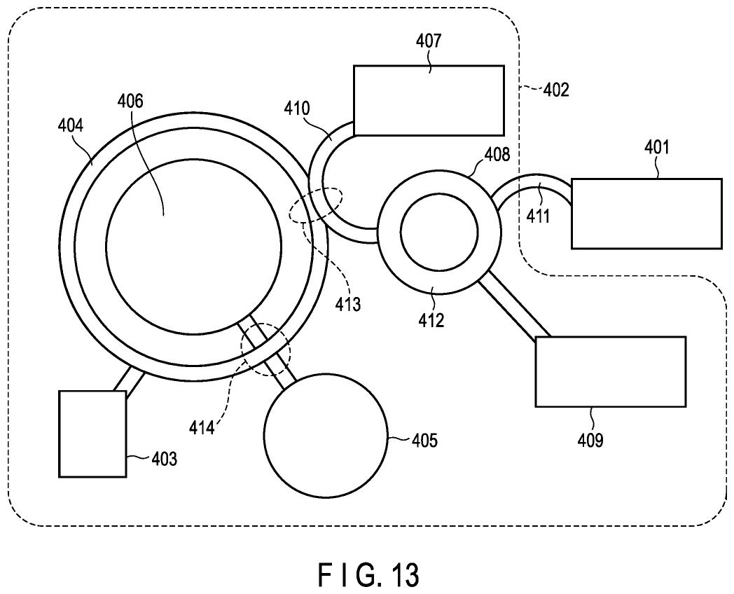

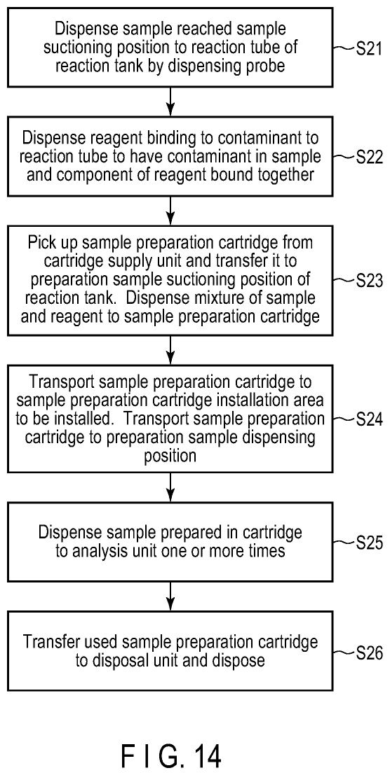

An example of a method for using an automatic analyzer which employs a suction type sample preparation cartridge will be described with reference to FIGS. 13 and 14. Note that in the fifth embodiment, it is assumed that the analyzer is a mass spectrometer, but some other analyzer may as well be used.

FIG. 13 is a block diagram illustrating the analysis unit of the automatic analyzer which uses a suction type sample preparation cartridge. The analysis unit 80 comprises a mass analysis unit 401 and a sample preparation area 402. The sample preparation area 402 further comprises a sample supply unit 403, a reaction tank 404, a first reagent storage unit 405, a second reagent storage unit 406, a sample preparation cartridge supply unit 407, a sample preparation cartridge installation area 408 and a disposal unit 409. The sample preparation cartridge supply unit 407 includes a sample preparation cartridge transfer mechanism 410 which comprises a mechanism for transferring the sample preparation cartridge and a sample suction mechanism for transferring a sample in the reaction tank to the sample preparation cartridge, and the sample preparation cartridge installation area 408 includes a preparation sample dispensing mechanism 411 for sending the sample to the mass spectrometer 401 and a mechanism 412 for transferring the sample preparation cartridge to the disposal unit 409.

FIG. 14 is a flowchart illustrating the procedure of analysis by the automatic analyzer which uses a suction type sample preparation cartridge.

The analyzer dispenses the sample having reached the sample suctioning position into a reaction tube 304 of the reaction tank 404 using the dispensing probe 316 (FIG. 14, (S21)). The reaction tube 304 reaches the reagent dispensing position 414 by the function of the reaction tank 404, and a reagent that binds to the contaminant 111 in the sample is dispensed into the reaction tube. The sample and the reagent are mixed in the reaction tube 304, and the contaminant 111 and the reagent react with each other. Thus, the contaminant 111 and the component of the reagent are bound together (FIG. 14, (S22)). In the case where there are two or more reagents, the reagents may be dispensed into the sample at one time, or they may be dispensed separately using different dispensing probes.

The sample preparation cartridge transfer mechanism 410 picks up the sample preparation cartridge 1 from the cartridge supply unit 407 and transfers the sample preparation cartridge to the preparation sample suctioning position 413 of the reaction tank 404. The sample preparation cartridge transfer mechanism 410 suctions the mixture of the sample and reagent in the reaction tube of the reaction tank 404 via the sample preparation cartridge and dispenses the mixture into the sample preparation cartridge (FIG. 14, (S23)). The sample preparation cartridge transfer mechanism 410 transports the sample preparation cartridge containing the mixed solution to a sample preparation cartridge installation position in the sample preparation cartridge installation area 408, to be installed there. The sample preparation cartridge installation area 408 further transports the sample preparation cartridge to the preparation sample dispensing position (FIG. 14, (S24)). The sample preparation is performed and completed in the process of transporting to the preparation sample dispensing position described above. After the sample preparation, the analyzer dispenses the prepared sample one or more times into the analysis unit using the preparation sample dispensing mechanism 411 (FIG. 14, (S25)). After that, the used sample preparation cartridges are transferred to the disposal unit 409 via the mechanism 412 for moving sample preparation cartridges, to be disposed (FIG. 14, (S26)).

According to the fifth embodiment, the automatic analyzer which employs the sample preparation cartridge can dispense a prepared sample held in the sample preparation cartridge directly to the analysis unit, thus making it possible to eliminate the need for separately providing a prepared sample storage area and a prepared sample storage container in the device. Thus, the mass spectrometer can be downsized. Further, since the preparation sample storage area is no longer necessary, a process for washing the container or a supply and disposal mechanism for the storage container are no longer required, thereby making it possible to reduce the measurement cost.

### EXAMPLES

### Example 1: Sample Preparation Method Using a Suction Type Sample Preparation Cartridge

### (Samples)

As the sample for Example 1, a sample containing mineral components such as Na, K and Mg, a component such as Cl and a protein is prepared. Note that a reagent has already been dispensed to the sample in advance at the analysis unit 80.

The contaminant 111 in the sample is a phospholipid, a high molecular weight protein or the like.

The reagent is in liquid form and it binds to the contaminant 111 in the sample. As a reagent that binds to a phospholipid, a solution containing titania particles or zirconia particles is used, and as a reagent that binds to a high molecular weight protein, trichloroacetic acid or methanol is used. The reagent that binds to the phospholipid and the reagent that binds to the high molecular weight protein may be dispensed both into the sample at once or each separately.

### (Sample Preparation Cartridge Used)

For the sample preparation cartridge, a sample suction type cartridge 1 is used. Further, in the sample preparation cartridge, the first capture unit 14 is a solid-phase extractant that captures proteins, and the second capture unit 15 is a filter.

### (Sample Preparation Method Using Sample Preparation Cartridge)

The sample of Example 1 is suctioned via the inflow channel 16 of the sample preparation cartridge 1 and sent to the second capture unit 15. The second capture unit 15 captures the contaminant 111 in the sample and removes the contaminant 111 from the sample. Further, the contaminant-removed sample 113 is sent to the second space 12 and retained in the second space 12. When the contaminant 111 is a phospholipid, the phospholipid binds to the titania or zirconia particles in the reagent and is removed by the filter of the second capture unit 15. When the contaminant 111 is a high molecular weight protein, the high molecular weight protein reacts with methanol in the reagent and protein precipitation occurs, which is then removed by the filter of the second capture unit 15.

Next, the second space 12 is pressurized and the first space 11 is depressurized, and the contaminant-removed sample 113 in the second space 12 is sent into the first space 11 via the first capture unit 14 and retained in the first space 11. When the sample in the second space 12 can be sent to the first space 11 only by pressurization, it suffices if the pressure of the second space 12 is increased.

After the protein in the sample is captured by the solid-phase extractant of the first capture unit 14, the remainder 114 retained in the first space 11 is in the state that the contaminant 111 and the protein have been removed from the sample. In other words, the remainder 114 of the sample in the first space 11 is in a state suitable for analysis of mineral components such as Na, K and Mg, and a component such as Cl. Then, the preparation sample dispensing mechanism of the automatic analyzer suctions the remainder 114 and dispenses it into the analysis unit 80 of the automatic analyzer.

Next, a liquid 115 for elution is dispensed into the second space 12. The elution liquid 115 is a liquid that elutes the protein component captured by the solid phase extractant in the first capture unit 14, such as methanol. The second space 12 is pressurized and the first space 11 is depressurized, and thus the elution liquid 115 is sent to the first capture unit 14. When the sample in the second space 12 can be sent to the first space 11 only by pressurization, it suffices if the pressure of the second space 12 is increased only. Then, the elution liquid 115 passes through the solid phase extractant in the first capture unit 14, and the protein component captured by the solid phase extractant is eluted. The eluate is sent into the first space 11 and retained in the first space 11. The sample preparation and dispensing mechanism of the automatic analyzer suctions the eluate in the first space 11 and dispenses it to the analysis unit 80 of the automatic analyzer.

As described above, with a single sample preparation cartridge, a sample suitable for the measurement of mineral components such as Na, K and Mg and a component such as Cl and a sample suitable for the measurement of protein components can be provided to the mass spectrometer. Note here that the component to be captured by the solid phase extractant may as well be a mineral component, and the first measurement may be carried out for protein components in the prepared sample.

### Example 2: Sample Preparation Method with Supply Type Sample Preparation Cartridge

### (Sample)

As a sample for Example 2, blood is prepared. When the blood is whole blood, an elution liquid 115 may be dispensed in advance to the blood sample.

As in the case of Example 1, the contaminant 111 in the sample is a phospholipid or the like or a high molecular weight protein, and reagents similar to those of Example 1 are used as well. The reagent that binds to the phospholipid and the reagent that binds to the high molecular weight protein may be dispensed both to the sample at once or each separately.

### (Sample Preparation Cartridge Used)

For the sample preparation cartridge, a sample supply type cartridge 2 is used. Further, in the cartridge, the first capture unit 14 is a filter, and the second capture unit 15 is a solid-phase extractant that captures the protein. Note that when a solid-phase extractant is used for the first capture unit 14, a solution for conditioning and equilibrating the solid-phase extractant is dispensed into the first capture unit 14 in advance at the time of dispensing the sample.

### (Analysis Using a Sample Preparation Cartridge)

A sample is dispensed into the first space 11 of the supply type sample preparation cartridge 2 via the sample supply unit 21. Along with the sample, a standard reference material whose concentration is known may as well be dispensed. The standard reference material is a solution used for relative measurement of the substance to be measured. Further, the solution for conditioning and equilibrating the solid-phase extractant is also dispensed into the second space 12. Furthermore, a solution containing titania particles is dispensed into the first space 11 as the reagent which binds to the phospholipid for capturing, and a methanol solution is dispensed as a reagent which reacts with the high molecular weight protein to generate protein precipitates.

Then, the opening of the outflow channel 22 communicated to the second capture unit 15 is closed, and the first space 11 is pressurized. Thus, the sample in the first space 11 is sent via the first capture unit 14 to the third space 13. The contaminant 111 in the sample is captured in the first capture unit 14, and the contaminant 111 is removed from the sample. The contaminant-removed sample 113 in the third space 13 further passes through the second capture unit 15, and the protein in the contaminant-removed sample 113 is captured by the solid phase extractant of the second capture unit 15.

The remainder 114 of the sample, having passed through the second capture unit 15 is dispensed into the analysis unit 80. Note that the remainder 114 may as well be supplied directly from the sample preparation cartridge 2 to the analysis unit 80 of the automatic analyzer. Or, a preparation space which can retain a prepared sample may be separately provided, and the remainder 114 may be supplied to the preparation space, and then fed to the mass spectrometer by the preparation sample dispensing mechanism of the analysis unit 80.

Next, the elution liquid 115 is dispensed into the second space 12. The elution liquid 115 is a liquid that elutes the protein component captured by the solid phase extractant of the second capture unit 15, such as methanol. While the opening of the first space 11 being closed, the second space 12 is pressurized to apply pressure to the second capture unit 15. With this operation, the elution liquid 115 is made to pass through the second capture unit 15, and thus an eluate in which the protein component captured by the solid phase extractant is eluted is obtained. Note that, thereafter, the eluate may be dispensed into the analysis unit 80 of the automatic analyzer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sample preparation cartridge comprising, in a container:
a first capture unit which captures an inclusion;
a second capture unit disposed to be spaced apart from the first capture unit, which captures a contaminant;
a first space provided on one surface side of the first capture unit;
a second space provided on one surface side of the second capture unit;
a third space provided between the first capture unit and the second capture unit; and
an inflow channel provided on an other side of the second capture unit,
the second space being provided in parallel with the first space and communicated to a third space.

2. The sample preparation cartridge of claim 1, wherein
the first capture unit is a solid-phase extractant.

3. A sample preparation cartridge comprising, in a container:
a second capture unit that captures an inclusion;
a first capture unit that captures a contaminant;
a first space provided on one surface side of the first capture unit;
a second space provided on one surface side of the second capture unit;
a third space provided between the first capture unit and the second capture unit; and
an outflow channel provided on an other side of the second capture unit,
the second space being provided in parallel with the first space and communicated to the third space.

4. The sample preparation cartridge of claim 3, wherein
the second capture unit is a solid-phase extractant.

5. The sample preparation cartridge of claim 2, wherein
a sample is passed through the solid-phase extractant, the inclusion is captured by the solid-phase extractant, and a remainder of the sample that passes through the solid-phase extractant is dispensed into an analysis unit of an automatic analyzer.

6. The sample preparation cartridge of claim 4, wherein
a sample is passed through the solid-phase extractant, the inclusion is captured by the solid-phase extractant, and a remainder of the sample that passes through the solid-phase extractant is dispensed into an analysis unit of an automatic analyzer.

7. The sample preparation cartridge of claim 2, wherein
a sample is passed through the solid-phase extractant, the inclusion is captured by the solid-phase extractant, and a remainder of the sample that passes through the solid-phase extractant is dispensed into an analysis unit of an automatic analyzer, and
further a liquid that can elute the inclusion is passed through the solid-phase extractant in which the inclusion is captured, an eluate in which the component captured by the solid-phase extractant is eluted is extracted, and the eluate is dispensed into the analysis unit of the automatic analyzer.

8. The sample preparation cartridge of claim 4, wherein
a sample is passed through the solid-phase extractant, the inclusion is captured by the solid-phase extractant, and a remainder of the sample that passes through the solid-phase extractant is dispensed into an analysis unit of an automatic analyzer, and
further a liquid that can elute the inclusion is passed through the solid-phase extractant in which the inclusion is captured, an eluate in which the component captured by the solid-phase extractant is eluted is extracted, and the eluate is dispensed into the analysis unit of the automatic analyzer.

9. An automatic analyzer for analysis using the sample preparation cartridge of claim 1, the analyzer comprising:
an analysis unit,
the analysis unit further comprising:
a mass spectrometer and a sample preparation area,
the sample preparation area comprising:
a sample supply unit, a reaction tank, a reagent storage unit, a sample preparation cartridge supply unit, a sample preparation cartridge installation mechanism and a disposal unit,
the sample preparation cartridge supply unit including a mechanism which transfers the sample preparation cartridge and a sample suction mechanism which transfers a sample in the reaction tank to the sample preparation cartridge, and
the sample preparation cartridge installation mechanism moves the sample preparation cartridge to the mass spectrometer or the disposal unit.

10. An automatic analyzer for analysis using the sample preparation cartridge of claim 2, the analyzer comprising:
an analysis unit,
the analysis unit further comprising:
a mass spectrometer and a sample preparation area,
the sample preparation area comprising:
a sample supply unit, a reaction tank, a reagent storage unit, a sample preparation cartridge supply unit, a sample preparation cartridge installation mechanism and a disposal unit,
the sample preparation cartridge supply unit including a mechanism which transfers the sample preparation cartridge and a sample suction mechanism which transfers a sample in the reaction tank to the sample preparation cartridge, and
the sample preparation cartridge installation mechanism moves the sample preparation cartridge to the mass spectrometer or the disposal unit.
